(19) United States
(12) Patent Application Publication
(10) Pub. No.: US 2025/0061585 A1
(43) Pub. Date: Feb. 20, 2025

(54) METHOD AND DEVICE FOR REAL-TIME TRACKING OF THE POSE OF A CAMERA BY AUTOMATIC MANAGEMENT OF A KEY-IMAGE DATABASE

(71) Applicants: SURGAR, CLERMONT-FERRAND (FR); UNIVERSITÉ CLERMONT-AUVERGNE, CLERMONT-FERRAND (FR); CENTRE NATIONAL DE LA RECHERCHE SCIENTIFIQUE, Paris (FR); CLERMONT AUVERGNE INP, Aubière (FR)

(72) Inventors: Adrien BARTOLI, Clermont-Ferrand (FR); Kilian CHANDELON, Les Martres De Veyre (FR)

(73) Assignees: SURGAR, CLERMONT-FERRAND (FR); UNIVERSITÉ CLERMONT AUVERGNE, CLERMONT-FERRAND (FR); CENTRE NATIONAL DE LA RECHERCHE SCIENTIFIQUE, Paris (FR); CLERMONT AUVERGNE INP, Aubière (FR)

(21) Appl. No.: 18/721,107

(22) PCT Filed: Dec. 14, 2022
(86) PCT No.: PCT/EP2022/085905

§ 371 Date: Jun. 17, 2024

(30) Foreign Application Priority Data
Dec. 15, 2021 (FR) FR2113591

(51) Int. Cl. G06T 7/20; G06T 17/00

(52) U.S. Cl. CPC G06T 7/20; G06T 17/00; G06T 2207/30244

(57) ABSTRACT

The invention relates to a method for real-time tracking of the placement of a camera with respect to a 3D model comprising a keyframe base comprising a first thread of execution making it possible to estimate the current placement of the camera from a selected keyframe, characterized in that the method further comprises a step of analyzing the quality of the estimation of the placement of the camera from the image stored in a buffer memory, and a step of analyzing the sharpness of the image stored in the buffer memory from data representative of the movement of the camera, and if the quality of the estimation of the placement of the camera from the stored image and the sharpness of the stored image conform to predetermined criteria, a step of adding the image stored in the buffer memory to the keyframe base as a new keyframe.

### TECHNICAL FIELD OF THE INVENTION

The invention relates to a method and a device for real-time tracking of the placement of a camera with respect to a 3D model, in particular for augmented reality applications, especially for endoscopic procedures, in particular laparoscopic procedures, for example for the purpose of robotized procedures or surgery. More particularly, the invention relates to a method and a device making possible the automatic management of a keyframe base, in particular the automatic adding of keyframes during the real-time tracking.

### TECHNOLOGICAL BACKGROUND

Laparoscopy is a medical technique for visual medical examination of the inside of the body of a patient using an endoscope, or more particularly a laparoscope when it is used to view the intra-abdominal and/or pelvic cavity of a patient. An endoscope generally comprises a light source and a means of capturing light, for example optical fibers and/or a video capture device.

During a surgical procedure by laparoscopy, the laparoscope makes possible direct or remote viewing of the intra-abdominal cavity and makes possible observation of the surgical site and direct intervention using surgical instruments. This surgical technique has the advantage of not necessitating a large opening in the abdominal wall (in contrast to laparotomy), making this a minimally invasive technique.

Analogously, minimally invasive surgical procedures using an endoscope can be implemented in the thoracic cavity (thoracoscopy) or in the pelvic cavity. The term endoscopic operation or surgical endoscopy is generally used.

Recent technological advances have developed laparoscopy from the medical personnel simply viewing the image of the zone to be operated on towards augmented viewing which makes it possible to display on the screen additional information in the viewed image so as to assist the medical personnel during the operation.

In particular, the computer vision techniques are used in the image obtained by the laparoscope in real time in order to provide additional information by augmented reality. For example, a hidden structure in the organ, such as a tumor, can be displayed in the image. In particular, it may be desired to display a operating site (for example, incision) in the image of the organ. More generally, the term computer-guided procedures or surgery is used in this context.

The placement of the camera, i.e. its position and its orientation in a given coordinate system, is calculated in real time with respect to a 3D model of the environment in which the camera is moving, so as to be able to display, in the image captured by the camera, augmented elements from a precalculated and preoperative augmented reality model. This pre-operative augmented reality model typically comes from preoperative or peroperative imaging by CT, MRI, US or other modality used in radiology. These preoperative or peroperative images, whether they are 2D or 3D, are assumed to be registered on the 3D model in advance.

In particular, the placement of the camera is calculated from a keyframe base and a base containing the placement of each keyframe in the repository of the 3D model of the peroperative environment which acts by comparing the current image with the keyframes of this keyframe base.

This method makes it possible to determine the placement of the camera in the known zones of the environment but does not make it possible to estimate the placement of the camera in the unexamined zones when no keyframe meets the criteria of similarity with the current image, or because of modifications in the appearance of the organ or of the cavity being filmed, in particular by movements, changes in color and/or textures caused by blood flow. The tracking of the placement of the camera is thus lost and it is not possible to display the augmented elements in the image captured by the camera.

Solutions have been proposed for the management of keyframes in the unexamined zones or the zones which change in appearance over time.

A first solution, in particular used in laparoscopic procedures, is to manually add keyframes to the database in order to complement the 3D model at different viewing angles. These additions are made according to visual criteria specific to the user, who estimates the relevance of the image for addition to the keyframe base.

This solution is restrictive, in particular within an operating framework, because it necessitates frequent interventions by the user via the dedicated man-machine interface (MMI) (touch-screen, keyboard, mouse, etc.) and is detrimental to the user-experience. Furthermore, the efficacy of this solution is strongly dependent on the operator in charge of it.

Other solutions have sought to automate the selection of new keyframes so as to relieve the user of the manual selection task. In particular, these proposed solutions involve the automatic updating of the keyframe base by use of different selection criteria.

However, these solutions are not optimal for use in a surgical context. In particular, the management of the database is complex and the automatic selection takes up a lot of physical resources (processing, graphical or storage resources, for example) and is not compatible with use in real time in a surgical context.

The inventors have thus sought to improve the automatic management of the keyframe base by defining relevant and effective criteria for selection of new keyframes without jeopardizing the overall performance of the system.

### AIMS OF THE INVENTION

The invention aims to provide a method and a device for real-time tracking of the placement of a camera with respect to a 3D model, making possible automated management of a keyframe base of the 3D model.

The invention aims to provide a tracking method and device making it possible for the placement of the camera and the sharpness of the image which is to be added to the keyframe base to be better taken into account.

The invention aims to provide a tracking method and device making it possible to relieve the user of the need to add new keyframes.

The invention aims to provide a tracking method and device making it possible to manage the keyframe base without having an impact on the processing of the real-time video stream from the camera.

### DESCRIPTION OF THE INVENTION

In order to achieve this, the invention relates to a method for real-time tracking of the placement of a camera with respect to a 3D model, said 3D model comprising a keyframe base and a base of placements which are associated with each keyframe, each keyframe being in particular characterized by reference points, said method comprising a first thread of execution comprising:
a step of receiving a video stream from the camera composed of a plurality of images,
a step of mapping reference points of the last received image of the video stream, referred to as the current image, with reference points of a keyframe of the 3D model by a mapping algorithm,
a step of estimating the current placement of the camera from the keyframe, referred to as the selected keyframe, comprising the highest number of reference points in common with the current image, by estimating the shift between the placement of the camera associated with the selected keyframe from the placement base and the current placement of the camera associated with the current image,

characterized in that the method further comprises:
if the number of reference points in common between the selected keyframe and the current image is lower than or equal to a predetermined threshold, a step of incrementing a loss-of-placement counter, or
if the number of reference points in common between the selected keyframe and the current image is higher than the predetermined threshold, a step of storing the current image of the video stream in a buffer memory,

and in that the method further comprises, if the loss-of-placement counter is higher than or equal to a predetermined value, a second thread of execution comprising:
a step of analyzing the quality of the estimation of the placement of the camera from the image stored in the buffer memory,
a step of analyzing the sharpness of the image stored in the buffer memory from data representative of the movement of the camera,
if the quality of the estimation of the placement of the camera from the stored image and the sharpness of the stored image conform to predetermined criteria, a step of adding the image stored in the buffer memory to the keyframe base as a new keyframe, otherwise a step of removing the image stored in the buffer memory.

A tracking method in accordance with the invention thus makes possible automated management of the keyframe base for the tracking of the placement of the camera by effecting a multi-criteria selection of new keyframes from images of the video stream coming from the camera. The management of the keyframe base is thus effected without manual intervention, which makes it possible to relieve the user of this task. The possibility of adding keyframes during the tracking method makes it possible to ensure the tracking irrespective of the viewing angle, in particular viewing angles not known initially in the 3D model, in particular zones never seen by the camera or zones which change appearance over time.

The 3D model is generated upstream of the tracking phase by methods of viewing on the basis of images, for example a method for acquiring structure from a movement, referred to as an SFM (structure-from-motion) method. The images obtained by this method can constitute a static part of the keyframe base, which cannot be modified during execution of the tracking method. The 3D model is complemented by new keyframes via the tracking method in accordance with the invention, these new keyframes forming a dynamic part of the keyframe base, which can be modified. The placement base is also updated upon each addition of a new keyframe in order to add the estimated placement of this new keyframe.

The automation of this management makes it possible to improve the repeatability of the tracking of the placement of the camera by rendering the process independent of the user.

In particular, the criteria for mapping between the current image and the keyframes of the keyframe base of the 3D model, the criterion for analysis of the quality of the estimation of the placement of the camera and the criterion for the sharpness of the image from data representative of the movement of the camera make possible an optimal selection of new keyframes, which is compatible with real-time usage.

The principle is to use an old image, which is a former current image placed in the buffer memory meeting these selection criteria in order to improve the tracking of the current image of the video stream when the placement of the camera is lost owing to the lack of keyframes sufficiently close to the current image captured by the camera. The use of this old image, which meets mapping criteria, makes it possible to be sure of having, as a reference, an image of the video stream which has been considered as making possible the tracking of the placement of the camera and to which the current tracking can be adjusted.

The 3D model thus complemented can make possible the addition, on a display of the video stream, of objects in augmented reality adjusted according to the placement of the camera which is known by virtue of the tracking method. For example, for an application in laparoscopy, 3D modeling of an organ can be displayed in augmented reality on the actual organ as captured by the camera and as displayed on the viewing screen. The updating of the keyframe base makes it possible to be sure that the placement of the camera is correctly tracked so that the display of the 3D modeling is permanently adjusted to the image of the actual organ. The 3D modeling can be complemented by invisible elements on the video stream, such as the presence of tumors, etc.

Advantageously and in accordance with the invention, the first thread of execution and the second thread of execution are executed in parallel.

According to this aspect of the invention, the threads of execution, also referred to as process or thread, do not impact each other. In particular, the management of the keyframe base, managed by the second thread of execution, referred to as the managing thread of the keyframe base, does not have an impact on the performance of the real-time tracking of the placement of the camera, managed by the first thread of execution, referred to as the tracking thread.

Advantageously and in accordance with the invention, the predetermined threshold is higher than or equal to fifty.

According to this aspect of the invention, the value of the predetermined threshold makes it possible to ensure that the image stored in the buffer memory comprises a large number of reference points with a keyframe in order to permit good tracking of the placement of the camera between these two images. In other variants of the invention, the predetermined threshold can be lower than fifty at the risk of reducing the quality of the estimation of the placement as the value of the threshold is low.

Advantageously and in accordance with the invention, the step of analyzing the quality of the estimation of the placement comprises at least one of the following sub-steps:
a sub-step of calculating the spatial coverage of the reference points,
a sub-step of calculating the error in the estimation of the estimated placement between the reference points observed in the image stored in the buffer memory and the reference points calculated from the selected image and the estimation of the placement.

According to this aspect of the invention, these sub-steps make it possible to be sure of the quality of the estimation of the placement of the camera for the selection of the image stored in the buffer memory as a new keyframe. The quality of the estimation of the placement is defined more precisely as the quality of the parameters calculated from the estimation of the placement with respect to the mapping of the reference points in the image stored in the buffer memory and the closest keyframe. In particular, the estimation error of the placement makes it possible to determine this quality of estimation of the placement by being sure that the estimation error of the parameters of the placement remain small with respect to the known placements assigned to the keyframes of the keyframe base. The calculation of the estimation error of the placement is calculated by calculated reprojection between the points observed in the current image and the points predicted by the transfer from the keyframes and the estimation of the placement.

The calculation of the estimation error of the placement can, for example, be a calculation of the mean square error of the placement or of the root of the mean square error of the placement.

Advantageously and in accordance with the invention, the step of analyzing the sharpness of the image comprises a sub-step of calculating the movement of reference points for the calculation of the speed and/or the acceleration and/or the jolt of said reference points.

According to this aspect of the invention, the sharpness of the image is taken into account for the selection of the image stored in the buffer memory as a new keyframe on the basis of the movement of the camera. The aim is to remove the images which are not sufficiently informative to be integrated into the keyframe base.

The jolt, also referred to as jerk or over-acceleration, is the derivative of the acceleration with respect to time. The acceleration is itself the derivative of the speed with respect to time and the speed is the derivative of the position with respect to time.

Advantageously and in accordance with the invention, the keyframe base comprises a static part comprising predefined static keyframes and a dynamic part which stores the new keyframes added in the step of adding the image stored in the buffer memory to the keyframe base.

According to this aspect of the invention, the preservation of the static keyframes of the static part of the keyframe base makes it possible to limit the derivatives to the estimation of the placement. In particular, the absence of static keyframes leads to a risk of drifting from the estimation of the placement, i.e. a progressive degradation in the estimation of the placement from the keyframes.

Advantageously and in accordance with the invention, the method comprises a step of measuring for each keyframe the duration from the last mapping of said keyframe with an image of the video stream, and in that, if the number of the keyframe is higher than or equal to a predetermined limit number of keyframes, the step of adding the image stored in the buffer memory to the keyframe base comprises a sub-step of removing the keyframe having the longest duration since the last mapping.

According to this aspect of the invention, the setting of a limit for keyframes in the keyframe base makes it possible to be sure that the mapping of the keyframes with the video stream does not impact too strongly on the calculation time of the machine executing the method, in particular in order to preserve the real-time aspect of the tracking method. If the keyframe base comprises so-called static keyframes in the static part of the keyframe base, these keyframes are not removed if the keyframe limit is reached and it is a non-static keyframe or a dynamic keyframe which is removed, i.e. a keyframe within the dynamic part of the keyframe base, in particular a keyframe which has been added earlier as the tracking method progresses. In other words, the management of the keyframe base can be effected only in a dynamic part of the keyframe base, which comprises keyframes able to be removed if necessary, and not have an impact on a static part of the keyframe base comprising static images which cannot be removed by this tracking method.

This limit number of keyframes can be, for example, between twenty and fifty for an application tracking the placement of an endoscope in a laparoscopy operation, in particular about thirty images for a good compromise between reasonable calculation time and robustness of the tracking of the placement of the camera. The limit number of keyframes is selected as a compromise between, on the one hand, the precision and the robustness of the tracking method and, on the other hand, the calculation speed and the number of images processed per second. The limit number of keyframes also depends on the equipment used and its resources.

The invention also relates to a device for real-time tracking of the placement of a camera with respect to a 3D model, said 3D model comprising a keyframe base and a base of placements which are associated with each keyframe, each keyframe being in particular characterized by reference points, said device comprising a first tracking module comprising:
a sub-module for receiving a video stream from the camera composed of a plurality of images,
a sub-module for mapping reference points of the last received image of the video stream, referred to as the current image, with reference points of a keyframe of the 3D model by a mapping algorithm,
a sub-module for estimating the current placement of the camera from the keyframe, referred to as the selected keyframe, comprising the highest number of reference points in common with the current image, by estimating the shift between the placement of the camera associated with the selected keyframe from the placement base and the current placement of the camera associated with the current image,

characterized in that the device further comprises a module for keyframe base management comprising:
a sub-module comprising a loss-of-placement counter incremented if the number of reference points in common between the selected keyframe and the current image is lower than or equal to a predetermined threshold,
a sub-module for transferring the current image of the video stream to a buffer memory of the device if the number of reference points in common between the selected keyframe and the current image is higher than the predetermined threshold,
a sub-module for comparing the value of the loss-of-placement counter with a predetermined value,
a sub-module for analyzing the quality of the estimation of the placement of the camera from the image stored in the buffer memory,
a sub-module for analyzing the sharpness of the image stored in the buffer memory from data representative of the movement of the camera,
a sub-module for managing the buffer memory, configured to add the image stored in the keyframe base if the quality of the estimation of the placement of the camera from the stored image and the sharpness of the stored image conform to predetermined criteria, and to remove the image stored in the buffer memory otherwise.

A module can consist, for example, of a computing device such as a computer, a group of computing devices, an electronic component or a group of electronic components, or, for example, a computer program, a group of computer programs, a library of a computer program or a function of a computer program executed by a computing device such as a computer, a group of computing devices, an electronic component or a group of electronic components.

Advantageously, the tracking device in accordance with the invention is configured to implement the tracking method in accordance with the invention.

Advantageously, the tracking method in accordance with the invention is implemented by a tracking device in accordance with the invention.

The invention also relates to a computer program product for real-time tracking of the placement of a camera with respect to a 3D model, said 3D model comprising a keyframe base and a base of placements which are associated with each keyframe, each keyframe being in particular characterized by reference points, said computer program product comprising program code instructions for the execution, when said computer program product is executed on a computer, of the steps of a method comprising a first thread of execution comprising:
a step of receiving a video stream from the camera composed of a plurality of images,
a step of mapping reference points of the last received image of the video stream, referred to as the current image, with reference points of a keyframe of the 3D model by a mapping algorithm,
a step of estimating the current placement of the camera from the keyframe, referred to as the selected keyframe, comprising the highest number of reference points in common with the current image, by estimating the shift between the placement of the camera associated with the selected keyframe from the placement base and the current placement of the camera associated with the current image, characterized in that

the method further comprises:
if the number of reference points in common between the selected keyframe and the current image is lower than or equal to a predetermined threshold, a step of incrementing a loss-of-placement counter, or
if the number of reference points in common between the selected keyframe and the current image is higher than the predetermined threshold, a step of storing the current image of the video stream in a buffer memory,

and in that the method further comprises, if the loss-of-placement counter is higher than or equal to a predetermined value, a second thread of execution comprising:
a step of analyzing the quality of the estimation of the placement of the camera from the image stored in the buffer memory,
a step of analyzing the sharpness of the image stored in the buffer memory from data representative of the movement of the camera,
if the quality of the estimation of the placement of the camera from the stored image and the sharpness of the stored image conform to predetermined criteria, a step of adding the image stored in the buffer memory to the keyframe base as a new keyframe, otherwise a step of removing the image stored in the buffer memory.

Advantageously, the computer program product in accordance with the invention is configured to implement the tracking method in accordance with the invention.

Advantageously, the tracking method in accordance with the invention is implemented by a computer program product in accordance with the invention.

The invention also relates to an endoscopic imaging system characterized in that it comprises an endoscope configured to capture a video stream, a tracking device in accordance with the invention configured for tracking the placement of the endoscope, and a viewing screen configured to display images acquired by the endoscope and additional information supplied by the processing unit according to the placement of the endoscope with respect to the 3D model.

The system is preferably used for laparoscopic, thoracoscopic or pelviscopic imaging.

The invention also relates to a tracking method, a tracking device and an endoscopic system which are characterized in combination by all or some of the features mentioned above or below.

### LIST OF FIGURES

Other aims, features and advantages of the invention will become apparent upon reading the following description given solely in a non-limiting way and which makes reference to the attached figures in which:

FIG. 1 is a schematic view of a laparoscopic imaging system in accordance with one embodiment of the invention,

FIG. 2 is a schematic view of the steps of a tracking method in accordance with one embodiment of the invention.

### DETAILED DESCRIPTION OF AN EMBODIMENT OF THE INVENTION

In the figures, for the purposes of illustration and clarity, scales and proportions have not been strictly respected.

Furthermore, identical, similar or analogous elements are designated by the same reference signs in all the figures.

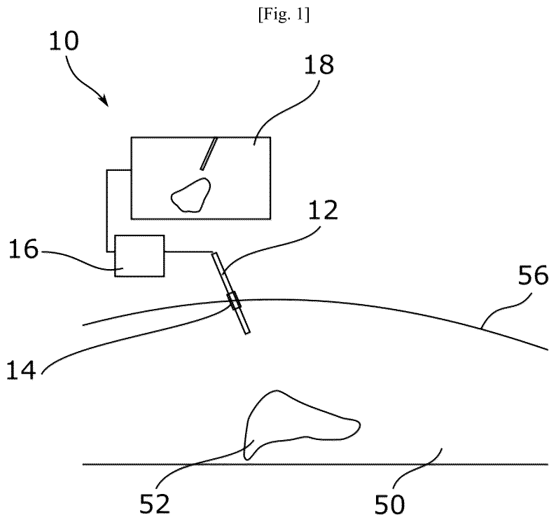

FIG. 1 schematically shows a laparoscopic imaging system 10 in accordance with one embodiment of the invention. The aim of the system is to make it possible to acquire and output images taken in a cavity 50 in the body of the patient, in this case a cavity in the abdomen of a patient (or abdominal cavity 50), in particular within the scope of a laparoscopic procedure, for example laparoscopic surgery. The laparoscopic surgical operation can be intended, for example, for operation on a target organ 52.

In order to do this, the system 10 comprises a tracking device in accordance with one embodiment of the invention, comprising, in particular, an endoscope 12 configured to acquire images of the abdominal cavity 50 of the patient. The endoscope 12 is disposed in the abdominal cavity 50 of the patient by means of a trocar 14 enabling the endoscope to pass through the abdominal wall 56. The endoscope used within a laparoscopic operation is currently referred to as a laparoscope.

The tracking device comprises a plurality of modules making it possible to implement a method in accordance with the invention, brought together in this case in a processing unit 16. The processing unit 16 is, for example, a computer or electronic board comprising a processor, for example, a processor dedicated to the processing of images of the method in accordance with the invention or even a general-purpose processor configured to execute, amongst a number of functions, in particular program instructions for execution of the steps of the method in accordance with the invention.

The images acquired from the endoscope 12 are displayed on a viewing screen 18 intended for the medical personnel. The acquired images can be augmented, i.e. comprise additional information added by the laparoscopic imaging system, which can come from the tracking device or other devices.

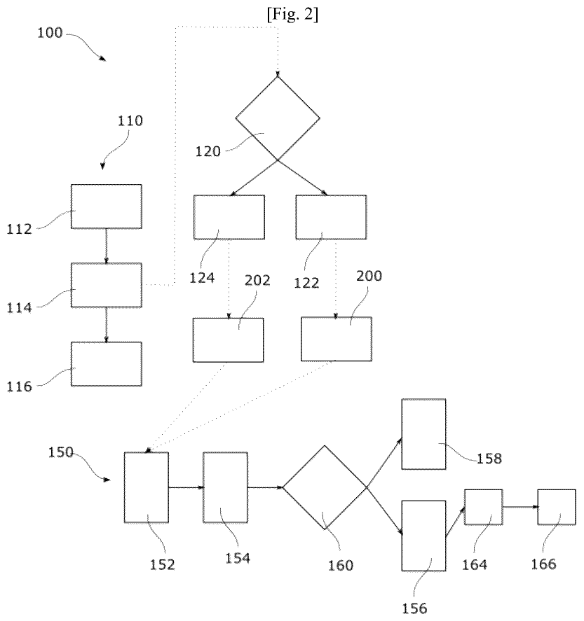

A tracking method 100 according to one embodiment of the invention comprises a number of steps illustrated with reference to FIG. 2.

The method 100 makes possible the real-time tracking of the placement of a camera with respect to a 3D model. The 3D model comprises a keyframe base which makes it possible to create a synthesis of a scene modeled by the model corresponding to an actual scene in which the camera is moving. Each keyframe is, in particular, characterized by reference points making it possible to effect mapping between the virtual scene of the 3D model and the actual scene captured by the camera, these reference points thus making it possible to deduce the placement of the camera.

The 3D model also comprises a placement base associating with each keyframe the placement of the camera during the taking of said keyframe. This placement base makes it possible to associate the keyframes with each other by their placement which is expressed in a common marker. The estimation of a change of placement is effected by estimation of the movement and/or the rotation according to this common marker.

The method comprises two threads of execution able to be executed in parallel, in particular a first thread of execution 110.

The first thread of execution 110 comprises a step 112 of receiving a video stream from the camera composed of a plurality of images. The camera is, for example, an endoscope filming a cavity of a patient.

The first thread of execution 110 then comprises a step 114 of mapping reference points of the last received image of the video stream, referred to as the current image, with reference points of a keyframe of the 3D model by a mapping algorithm. This step makes it possible to verify the mapping of the current image with one of the keyframes of the 3D model.

The first thread of execution 110 then comprises a step 116 of estimating the current placement of the camera from the keyframe, referred to as the selected keyframe, comprising the highest number of reference points in common with the current image. The mapping between the current image and the keyframe makes it possible to determine that the camera has a placement close to a placement of the camera having made it possible to obtain said selected keyframe, and thus to deduce therefrom the placement of the camera during taking of the current image, by estimating the shift between the placement of the camera associated with the selected keyframe from the placement base and the current placement of the camera associated with the current image. In particular, the placement is estimated by estimating parameters of the placement, for example parameters of rotation and translation of the current placement, which are expressed according to a reference placement, i.e. in this context, the placement associated with the selected keyframe.

In practice, the comparison of the current image with the keyframes of the keyframe base is effected via a preprocessing of the image (for example, color channel extraction in accordance with the application, application of Gaussian blur, redimensioning the image, etc.) making it possible to easily extract therefrom the reference points by virtue of, for example, a detector of the scale-invariant feature transform, SIFT, type. The reference points are then compared, by a comparison method, for example, by a mapping algorithm, in particular a brute force matching (BFT) algorithm.

The estimation of the placement is then effected from the most relevant image, the selected image, for example by a robust estimator, in particular by a perspective-n-point projection, PnP, in particular of the PnP RANSAC type using the iterative parameter estimation method, RANSAC, for RANdom SAmple Consensus.

When the estimation of the placement is sufficiently reliable, the tracking device can augment the image of the video stream by augmented reality.

The method comprises steps which may or may not be included in the first thread of execution, which are based on a step 120 of comparing the number of reference points in common between the selected keyframe and the current image. These steps can be implemented from mappings between the current image and the keyframes obtained in the mapping step 114.

If the number of reference points in common between the selected keyframe and the current image is higher than a predetermined threshold, preferably between 20 and 100, for example fifty, the method comprises a step 122 of storing the current image in a buffer memory 200. This step makes possible the processing of the current image outside the first thread of execution 110, preserving the image while the video stream provided to the unit for processing new images captured by the camera [sic].

If the number of reference points in common between the selected keyframe and the current image is lower than or equal to the predetermined threshold, the method comprises a step 124 of incrementing a loss-of-placement counter 202 is executed [sic]. This counter makes it possible to detect a loss of placement of the camera when no keyframe of the keyframe base makes it possible for the placement of the camera to be estimated. When the placement of the camera is lost, it is no longer possible to display additional information by augmented reality.

If the loss-of-placement counter is higher than or equal to a predetermined value, a second thread of execution 150 of the method is implemented.

This second thread of execution 150 is intended to manage the keyframe base, in particular to add new images to the keyframe base if these images make it possible to improve the tracking of the camera, in particular in zones which have previously not been captured or only slightly captured by the camera or which have changed in appearance over time, and for which the 3D model does not have sufficient keyframes.

The second thread of execution 150 comprises a step 152 of analyzing the quality of the estimation of the placement of the camera from the image stored in the buffer memory,

In particular, the step 152 of analyzing the quality of the estimation of the placement comprises at least one of the following sub-steps:
a sub-step of calculating the spatial coverage of the reference points,
a sub-step of calculating the estimation error of the placement, also referred to as the reprojection error, for example by calculation of the mean square error of the placement or of the root of the mean square error of the placement. This error is quantifiable during the estimation of the placement described above, during the application of the PnP-type algorithm, in particular PnP RANSAC. The mean square error is referred to, in particular, as MSE and the root of the mean square error is referred to, in particular, as RMSE.

The second thread of execution 150 then comprises a step 154 of analyzing the sharpness of the image stored in the buffer memory from data representative of the movement of the camera. The sharpness of the image is then, for example, estimated according to data representative of the position, of the movement, of the speed, of the acceleration and/or of the jolt of the camera, which makes it possible to be sure that a good quality image is preserved for possible addition to the keyframe base. In particular, the step 154 of analyzing the sharpness of the image comprises a sub-step of calculating the movement of reference points, for the calculation of the speed and/or the acceleration and/or the jolt of said reference points with respect to the reference points of the selected keyframe. The analysis of the sharpness of the image stored in the buffer memory can be complemented by calculation of the variance of the Laplacian in order to validate the analysis.

If the quality of the estimation of the placement of the camera from the stored image and of the sharpness of the stored image conform to predetermined criteria, verified in a step 160 of verification of the placement and the sharpness, the second thread of execution 150 then comprises a step 156 of adding the image stored in the buffer memory to the keyframe base as a new keyframe, otherwise a step 158 of removing the image stored in the buffer memory.

This adding step makes it possible to use the image stored in the buffer memory, which is an image from the past, in order to improve the tracking of the next placements of the camera by adding it into the keyframe base if the tracking of the placement is lost for lack of keyframes sufficiently close to the current image of the video stream captured by the camera. The placement base is also updated in order to preserve the placement information associated with the new keyframe.

For reasons related to the overall performance of the method, the tracking method 100 can also comprise a step 164 of measuring for each keyframe the duration from the last mapping of said keyframe with an image of the video stream, and if the number of the keyframe is higher than or equal to a predetermined limit number, the step of adding the image stored in the buffer memory to the keyframe base comprises a sub-step 166 of removing the keyframe having the longest duration since the last mapping.

The invention is not limited to the embodiment described. In particular, the invention is applicable to any type of endoscopic imaging system within the scope of endoscopy, for example in the thoracic or pelvic cavity, as well as more generally to any system using augmented reality and requiring the tracking of the placement of a camera for displaying a 3D model on an actual video stream captured by the camera.

1. A method for real-time tracking of the placement of a camera with respect to a 3D model, said 3D model comprising a keyframe base and a base of placements which are associated with each keyframe, each keyframe being in particular characterized by reference points, said method comprising steps of a first thread of execution comprising:
a step of receiving a video stream from the camera composed of a plurality of images,
a step of mapping reference points of the last received image of the video stream, referred to as the current image, with reference points of a keyframe of the 3D model by a mapping algorithm,
a step of estimating the current placement of the camera from the keyframe, referred to as the selected keyframe, comprising the highest number of reference points in common with the current image, by estimating the shift between the placement of the camera associated with the selected keyframe from the placement base and the current placement of the camera associated with the current image,
a step of incrementing a loss-of-placement counter on condition that the number of reference points in common between the selected keyframe and the current image is lower than or equal to a predetermined threshold, or
a step of storing the current image of the video stream in a buffer memory on condition that the number of reference points in common between the selected keyframe and the current image is higher than the predetermined threshold, and
on condition that the loss-of-placement counter is higher than or equal to a predetermined value, performing steps of a second thread of execution comprising:
a step of analyzing the quality of the estimation of the placement of the camera from the image stored in the buffer memory,
a step of analyzing the sharpness of the image stored in the buffer memory from data representative of the movement of the camera,
a step of adding the image stored in the buffer memory to the keyframe base as a new keyframe, on condition that the quality of the estimation of the placement of the camera from the stored image and the sharpness of the stored image conform to predetermined criteria, but otherwise a step of removing the image stored in the buffer memory.

2. The tracking method as claimed in claim 1, wherein the steps of the first thread of execution and the steps of the second thread of execution are performed in parallel.

3. The tracking method as claimed in claim 1, wherein the predetermined threshold is greater than or equal to fifty.

4. The tracking method as claimed in claim 1, wherein the step of analyzing the quality of the estimation of the placement comprises at least one of the following sub-steps:
a sub-step of calculating the spatial coverage of the reference points,
a sub-step of calculating the error in the estimation of the estimated placement between the reference points observed in the image stored in the buffer memory and the reference points calculated from the selected image and the estimation of the placement.

5. The tracking method as claimed in claims 1, wherein the step of analyzing the sharpness of the image comprises a sub-step of calculating the movement of reference points for the calculation of the speed and/or the acceleration and/or the jolt of said reference points.

6. The tracking method as claimed in as claimed in claim 1, wherein the keyframe base comprises a static part comprising predefined static keyframes and a dynamic part which stores the new keyframes added in the step adding of adding the image stored in the buffer memory to the keyframe base.

7. The tracking method as claimed in as claimed in claim 1, further comprising a step of measuring for each keyframe the duration from the last mapping of said keyframe with an image of the video stream, and in that, if the number of the keyframe is higher than or equal to a predetermined limit number, the step of adding the image stored in the buffer memory to the keyframe base comprises a sub-step of removing the keyframe having the longest duration since the last mapping.

8. A device for real-time tracking of the placement of a camera with respect to a 3D model, said 3D model comprising a keyframe base and a base of placements which are associated with each keyframe, each keyframe being in particular characterized by reference points, said device comprising a first tracking module comprising:
a sub-module for receiving a video stream from the camera composed of a plurality of images,
a sub-module for mapping reference points of the last received image of the video stream, referred to as the current image, with reference points of a keyframe of the 3D model by a mapping algorithm,
a sub-module for estimating the current placement of the camera from the keyframe, referred to as the selected keyframe, comprising the highest number of reference points in common with the current image, by estimating the shift between the placement of the camera associated with the selected keyframe from the placement base and the current placement of the camera associated with the current image,
characterized in that the device further comprises a module for managing the keyframe base comprising:
a sub-module comprising a loss-of-placement counter incremented if the number of reference points in common between the selected keyframe and the current image is lower than or equal to a predetermined threshold,
a sub-module for transferring the current image of the video stream to a buffer memory of the device if the number of reference points in common between the selected keyframe and the current image is higher than the predetermined threshold,
a sub-module for comparing the value of the loss-of-placement counter with a predetermined value,
a sub-module for analyzing the quality of the estimation of the placement of the camera from the image stored in the buffer memory,
a sub-module for analyzing the sharpness of the image stored in the buffer memory from data representative of the movement of the camera,
a sub-module for managing the buffer memory, configured to add the image stored in the keyframe base if the quality of the estimation of the placement of the camera from the stored image and the sharpness of the stored image conform to predetermined criteria, and to remove the image stored in the buffer memory otherwise.

9. A computer program product for real-time tracking of the placement of a camera with respect to a 3D model, said 3D model comprising a keyframe base and a base of placements which are associated with each keyframe, each keyframe being in particular characterized by reference points, said computer program product comprising program code instructions which when executing, perform steps of a a first thread of execution comprising:
a step of receiving a video stream from the camera composed of a plurality of images,
a step of mapping reference points of the last received image of the video stream, referred to as the current image, with reference points of a keyframe of the 3D model by a mapping algorithm,
a step of estimating the current placement of the camera from the keyframe, referred to as the selected keyframe, comprising the highest number of reference points in common with the current image, by estimating the shift between the placement of the camera associated with the selected keyframe from the placement base and the current placement of the camera associated with the current image,
a step of incrementing a loss-of-placement counter on condition that the number of reference points in common between the selected keyframe and the current image is lower than or equal to a predetermined threshold,
a step of storing the current image of the video stream in a buffer memory on condition that the number of reference points in common between the selected keyframe and the current image is higher than the predetermined threshold, and
on condition that the loss-of-placement counter is higher than or equal to a predetermined value performing steps of a second thread of execution comprising:
a step of analyzing the quality of the estimation of the placement of the camera from the image stored in the buffer memory,
a step of analyzing the sharpness of the image stored in the buffer memory from data representative of the movement of the camera,
a step of adding the image stored in the buffer memory to the keyframe base as a new keyframe on condition that the quality of the estimation of the placement of the camera from the stored image and the sharpness of the stored image conform to predetermined criteria, but otherwise performing a step of removing the image stored in the buffer memory.

10. (canceled)
